(19) United States
(12) Patent Application Publication
(10) Pub. No.: US 2021/0204331 A1
(43) Pub. Date: Jul. 1, 2021

(54) RANDOM ACCESS INFORMATION OBTAINING METHOD, RANDOM ACCESS INFORMATION SENDING METHOD, AND NETWORK NODE

(71) Applicant: VIVO MOBILE COMMUNICATION CO., LTD., Dongguan (CN)

(72) Inventor: Yue MA, Dongguan (CN)

(73) Assignee: VIVO MOBILE COMMUNICATION CO., LTD., Dongguan (CN)

(21) Appl. No.: 17/202,379

(22) Filed: Mar. 16, 2021

Related U.S. Application Data
(63) Continuation of application No. PCT/CN2019/106660, filed on Sep. 19, 2019.

(30) Foreign Application Priority Data
Sep. 19, 2018 (CN) 201811095937.6

(51) Int. Cl. H04W 74/08; H04W 76/27

(52) U.S. Cl. CPC H04W 74/0833; H04W 76/27

(57) ABSTRACT

The disclosure provides a random access information obtaining method, user equipment, and a network side device. The random access information obtaining method applied to user equipment may include receiving a random access response sent by a network side device, where the random access response may include at least one of the following: a reserved bit, an uplink grant, a backoff indicator, a timing advance, an identifier (ID) of a preamble sequence or another sequence, a terminal ID, a contention resolution ID, a radio resource control (RRC) message, an association relationship between RRC messages and IDs, or a radio network temporary identifier in a connected state. Here, the IDs may include at least one of the following: the ID of the preamble sequence or the another sequence, the terminal ID, or the contention resolution ID.

### CROSS-REFERENCE TO RELATED APPLICATIONS

This application is a bypass continuation of PCT Application No. PCT/CN2019/106660 filed Sep. 19, 2019, which claims priority to Chinese Patent Application No. 201811095937.6 filed in China on Sep. 19, 2018, both of which are incorporated herein by reference in their entireties.

### TECHNICAL FIELD

The present disclosure relates to the field of communications technologies, and in particular, to a random access information obtaining method, a random access information sending method, and a network node.

### BACKGROUND

In a conventional random access procedure, user equipment needs to perform four steps (except a complete message) to complete random access in an idle state, and the four steps are referred to as 4-step random access (4-step RACH). Currently, a technical solution is proposed. The user equipment needs to perform two steps to complete random access in an idle state, and the two steps are referred to as 2-step random access (2-step RACH).

However, for the 2-step RACH, a design scheme of a random access response is not clear.

### SUMMARY

A technical problem to be resolved in the present disclosure is to provide a random access information obtaining method, a random access information sending method, and a network node, so that content of a random access response in a 2-step random access procedure can be clear.

To resolve the foregoing technical problem, the embodiments of the present disclosure provide the following technical solutions:

According to a first aspect, an embodiment of the present disclosure provides a random access information obtaining method that is applied to user equipment, and the method includes: receiving a random access response sent by a network side device, where the random access response includes at least one of the following: a reserved bit, an uplink grant, a backoff indicator, a timing advance, an identifier (ID) of a preamble sequence or another sequence, a terminal ID, a contention resolution ID, a radio resource control (RRC) message, an association relationship between RRC messages and IDs, or a radio network temporary identifier in a connected state, and the IDs include at least one of the following: the ID of the preamble sequence or the another sequence, the terminal ID, or the contention resolution ID.

According to a second aspect, an embodiment of the present disclosure provides a random access information sending method that is applied to a network side device, and the method includes: sending a random access response to user equipment, where the random access response includes at least one of the following: a reserved bit, an uplink grant, a backoff indicator, a timing advance, an ID of a preamble sequence or another sequence, a terminal ID, a contention resolution ID, an RRC message, an association relationship between RRC messages and IDs, or a radio network temporary identifier in a connected state, and the IDs include at least one of the following: the ID of the preamble sequence or the another sequence, the terminal ID, or the contention resolution ID.

According to a third aspect, an embodiment of the present disclosure provides user equipment, including: a receiving module, configured to receive a random access response sent by a network side device, where the random access response includes at least one of the following: a reserved bit, an uplink grant, a backoff indicator, a timing advance, an ID of a preamble sequence or another sequence, a terminal ID, a contention resolution ID, an RRC message, an association relationship between RRC messages and IDs, or a radio network temporary identifier in a connected state, and the IDs include at least one of the following: the ID of the preamble sequence or the another sequence, the terminal ID, or the contention resolution ID.

According to a fourth aspect, an embodiment of the present disclosure provides a network side device, including: a sending module, configured to send a random access response to user equipment, where the random access response includes at least one of the following: a reserved bit, an uplink grant, a backoff indicator, a timing advance, an ID of a preamble sequence or another sequence, a terminal ID, a contention resolution ID, an RRC message, an association relationship between RRC messages and IDs, or a radio network temporary identifier in a connected state, and the IDs include at least one of the following: the ID of the preamble sequence or the another sequence, the terminal ID, or the contention resolution ID.

According to a fifth aspect, an embodiment of the present disclosure provides a network node, including a memory, a processor, and a computer program that is stored in the memory and that can run on the processor, where when the computer program is executed by the processor, steps in the foregoing random access information obtaining method are implemented, or steps in the foregoing random access information sending method are implemented.

According to a sixth aspect, an embodiment of the present disclosure provides a computer-readable storage medium, where the computer-readable storage medium stores a computer program, and when the computer program is executed by a processor, steps in the foregoing random access information obtaining method are implemented, or steps in the foregoing random access information sending method are implemented.

The embodiments of the present disclosure have the following beneficial effects:

By using the technical solution of the present disclosure, content of a random access response in a 2-step random access procedure may be clear.

### BRIEF DESCRIPTION OF DRAWINGS

FIG. 1 is a schematic flowchart of 4-step random access in related technology;

FIG. 2 is a schematic flowchart of 2-step random access;

FIG. 3 is an example diagram of a MAC protocol data unit formed by a MAC random access response;

FIG. 4 is a schematic structural diagram of a MAC RAR;

FIG. 5 is a schematic flowchart of a random access information obtaining method applied to user equipment according to an embodiment of the present disclosure;

FIG. 6 is a schematic flowchart of a random access information sending method applied to a network side device according to an embodiment of the present disclosure;

FIG. 7 is a schematic structural diagram of user equipment according to an embodiment of the present disclosure;

FIG. 8 is a schematic structural diagram of a network side device according to an embodiment of the present disclosure;

FIG. 9 is a schematic diagram of composition of a network side device according to an embodiment of the present disclosure; and

FIG. 10 is a schematic diagram of composition of user equipment according to an embodiment of the present disclosure.

### DETAILED DESCRIPTION

To make the to-be-resolved technical problems, technical solutions, and advantages in the embodiments of the present disclosure clearer, detailed descriptions are provided below with reference to the accompanying drawings and specific embodiments.

In the embodiments of the present disclosure, user equipment may be a terminal side device such as a mobile phone, a tablet personal computer, a laptop computer, a personal digital assistant (PDA), a mobile internet device (MID), a wearable device, or an in-vehicle device. It should be noted that, a specific type of the user equipment is not limited in the embodiments of the present disclosure.

A network side device may be a base station, a relay, an access point, or the like. The base station may be a base station (for example, a 5G new ratio (NR) NB) of 5G and later versions, or a base station (for example, an evolutional NodeB (eNB)) in another communications system. It should be noted that a specific type of the network side device is not limited in the embodiments of the present disclosure.

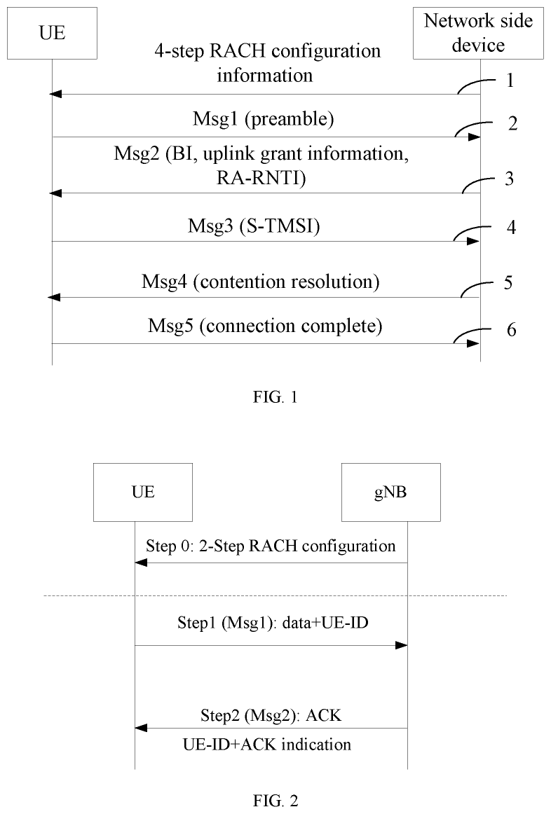

As shown in FIG. 1, a 4-step random access procedure includes the following steps:

Step 1: A network side device configures 4-step random access configuration information (4-step RACH configuration) for user equipment (UE).

Step 2: The UE sends Msg1 to the network side device.

In this step, Msg1 may include a random access preamble, but is not limited thereto.

Step 3: The network side device sends Msg2 to the UE.

In this step, Msg2 may be presented as a random access response (RAR) message. Msg2 may include a backoff indicator (BI), uplink grant information, and a random access-radio network temporary identifier (RA-RNTI).

However, it should be understood that, in actual application, Msg2 may include one or a combination of more of the BI, the uplink grant information, and the RA-RNTI. Certainly, Msg2 may further include other information, for example, a timing advance command (TAC).

Step 4: The UE sends Msg3 to the network side device.

In this step, Msg3 may be presented as an RRC connection request message. Msg2 may include, but is not limited to, a system architecture evolution (SAE) temporary mobile station identifier (S-TMSI).

Step 5: The network side device sends Msg4 to the UE.

In this step, Msg4 may be presented as an RRC connection setup message. Msg3 may include, but is not limited to, contention resolution.

Step 6: The UE sends Msg5 to the network side device.

In this step, Msg5 may be represented as an RRC connection complete message.

For 4-step random access, it should be noted that, in a conventional sense, Msg1 to Msg5 may present different message forms in a specific connection setup process in a connected state and an idle state. Msg1 to Msg5 in the 4-step random access procedure may be an RRC message, a media access control (MAC) control element (CE), a physical layer indication, data, a sequence, or the like.

As shown in FIG. 2, a 2-step random access procedure includes the following steps:

Step 0: A network side (gNB) configures 2-step random access configuration information (2-step RACH configuration) for user equipment, for example, including transmission resource information corresponding to Msg1 and Msg2.

Step 1: The UE triggers a 2-step RACH procedure. Request information (Msg1) is sent to a network side, for example, data and a UE identifier (UE-ID) are sent by using a physical uplink shared channel (PUSCH).

Step 2: The network side sends acknowledgment information (Msg2) to the UE. If the UE fails to receive Msg2, the UE sends Msg1 again.

For 2-step random access, it should be noted that Msg1 and Msg2 may present different message forms in a specific connection setup process in a connected state and an idle state, which is distinguished from Msg1 to Msg5 in the conventional 4-step random access. Msg1 and Msg2 in the 2-step random access may be an RRC message, a MAC CE, a physical layer indication, data, a sequence, or the like.

For 2-step RACH, step 1 is equivalent to combining Msg1 and Msg3 in the conventional RACH procedure and sending Msg1 and Msg3 together, and step 2 is equivalent to combining Msg 2 and Msg 4 in the conventional RACH procedure and sending Msg2 and Msg4 together.

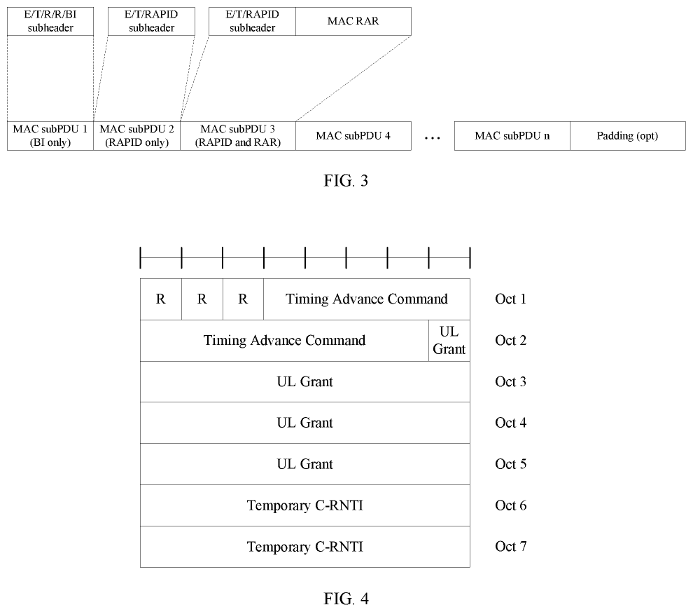

FIG. 3 is an example of a MAC protocol data unit (PDU) formed by a media access control random access response (RAR), and FIG. 4 is a schematic structural diagram of the MAC RAR.

Briefly, the RAR is divided into three types of MAC sub-PDUs. One type has only a BI, one type has only a random access preamble identifier (RAPID), and one type has a RAPID and a RAR. Payload content of the RAR includes a timing advance command, an uplink grant (UL Grant), and a temporary cell radio network temporary identifier (C-RNTI). A function of the sub PDU that has only the BI is to execute the BI for UE that does not detect the RAPID. A function of the sub PDU that has only the RAPID is being used as an ACK of a system information (SI) request for UE that detects the RAPID. A function of the sub PDU that has the PRAPID and the RAR is to execute corresponding RAR content for the UE that detects the RAPID.

For the 4-step RACH procedure, to be specific, UE that is in an idle (IDLE)/inactive state and that uses 4-step in a process of converting from the IDLE/inactive state to a connected state, when receiving the RAR, after detecting a RAPID of the UE, the UE obtains a corresponding uplink grant, sends Msg3 on the uplink grant, completes contention resolution by using Msg4, provides a reconfiguration message by using Msg4, and upgrades a T-C-RNTI to a C-RNTI. Then, the network side may perform scheduling by using the C-RNTI.

However, it is not clear how to complete functions of Msg2 and Msg4 in 4-step RACH in the random access response for 2-step RACH, and how to calculate the random access-radio network temporary identifier used in the random access response.

To resolve the foregoing problems, the embodiments of the present disclosure provide a random access information obtaining method and a network node, so that content of a random access response in a 2-step random access procedure can be clear.

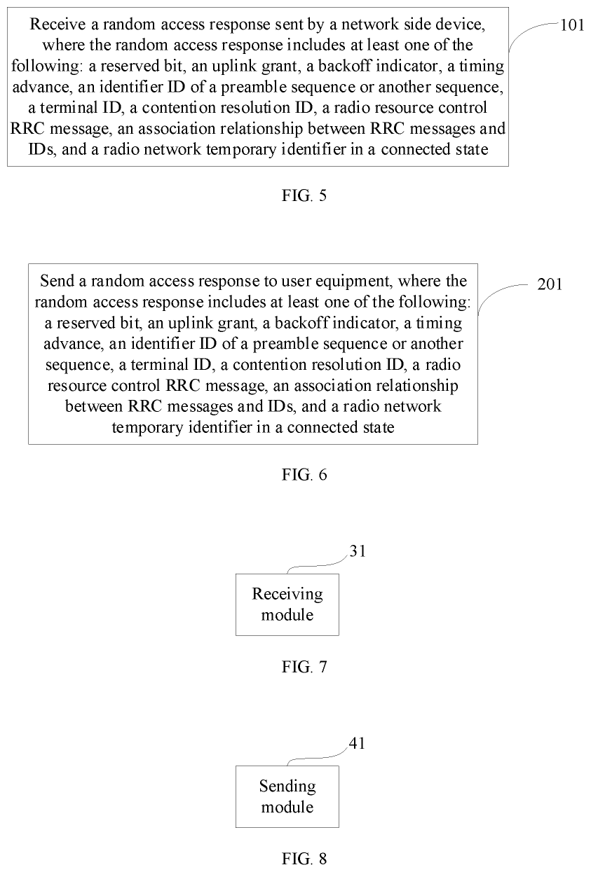

An embodiment of the present disclosure provides a random access information obtaining method that is applied to user equipment. As shown in FIG. 5, the method includes the following steps.

Step 101: Receive a random access response sent by a network side device, where the random access response includes at least one of the following: a reserved bit, an uplink grant, a backoff indicator, a timing advance, an ID of a preamble sequence or another sequence, a terminal ID, a contention resolution ID, an RRC message, an association relationship between RRC messages and IDs, or a radio network temporary identifier in a connected state, and the IDs include at least one of the following: the ID of the preamble sequence or the another sequence, the terminal ID, or the contention resolution ID.

Content of a random access response in a 2-step random access procedure can be clear in this embodiment.

Further, the method further includes:

calculating a random access-radio network temporary identifier such as an RA-RNTI based on transmission resource information in a random access procedure.

Receiving a random access response sent by a network side device includes:

receiving the random access response by using the random access-radio network temporary identifier.

Further, the method further includes:

sending a random access request to the network side device; where

the transmission resource information includes a time domain resource and/or a frequency domain resource and/or a space domain resource and/or a power domain resource that are/is corresponding to a random access preamble sequence or another code sequence and that are carried in the random access request; and/or

the random access request carries a time domain resource and/or a frequency domain resource and/or a space domain resource and/or a power domain resource that are/is corresponding to a physical uplink shared channel used for transmission.

Further, calculating the random access-radio network temporary identifier includes:

calculating the random access-radio network temporary identifier based on the time domain resource and/or the frequency domain resource and/or the space domain resource and/or the power domain resource that are/is corresponding to the random access preamble sequence or the another code sequence and that are carried in the random access request; and/or

calculating the random access-radio network temporary identifier based on the time domain resource and/or the frequency domain resource and/or the space domain resource and/or the power domain resource that are/is corresponding to the physical uplink shared channel used for transmission.

For UE that is in an IDLE/inactive state and that uses 2-step RACH in a process of converting from the IDLE/inactive state to a connected state, when receiving the RAR, the UE needs to complete functions such as contention resolution, message reconfiguration, and C-RNTI determining.

Similar to a long term evolution (LTE) mechanism, a format of the RAR includes information of multiple pieces of UE, and the multiple pieces of UE may detect a random access-radio network temporary identifier (RA-RNTI). Each UE detects, based on a corresponding RAPID, an ID of a random access preamble sent by the UE.

Msg1 for initiating RACH may use a preamble or a physical uplink shared channel (PUSCH) or a combination thereof. For calculation of the RA-RNTI, the following calculation parameters may be used:

the preamble used by Msg1 to initiate RACH and a corresponding time domain resource and/or frequency domain resource and/or space domain resource and/or power domain resource; and/or

a PUSCH used by Msg1 to initiate RACH and a corresponding time domain resource and/or frequency domain resource and/or space domain resource and/or power domain resource.

Further, when a control resource set frequency domain location of a random access response in the 2-step random access procedure is different from a control resource set frequency domain location of a random access response in the 4-step random access procedure, the random access-radio network temporary identifier is calculated by using at least one of the following parameters:

a sequence number of the first orthogonal frequency division multiplexing symbol (OFDM) location of a physical random access channel (PRACH) corresponding to a 2-step random access procedure, a sequence number of the first timeslot of a system frame at which the PRACH channel corresponding to the 2-step random access procedure is located, a sequence number of a frequency domain location of the PRACH channel corresponding to the 2-step random access procedure, or an indication of an uplink carrier for sending the random access request.

Specifically, if a control resource set (coreset) frequency domain location at which the RAR is received in 2-step RACH is different from that in conventional RACH (that is, 4-step RACH), the following formula may be used to calculate the RA-RNTI:

RA-RNTI=1+s_id+14×t_id+14×80×f_id+14×80×8×ul_carrier_id(2-step RACH carrier), where

s_id is a sequence number of the first OFDM location of a PRACH corresponding to a 2-step random access procedure, 0≤s_id<14, t_id is a sequence number of the first timeslot of a system frame at which the PRACH channel corresponding to the 2-step random access procedure is located, 0≤t_id≤80, fid is a sequence number of a frequency domain location of the PRACH channel corresponding to the 2-step random access procedure, and ul_carrier_id is an indication of an uplink carrier for sending the random access request. For 2-step RACH, a value of ul_carrier_id may be 1, and for 4-step RACH, a value of ul_carrier_id may be 0. Alternatively, for 4-step RACH, a value of ul_carrier_id may be 0; for an uplink auxiliary carrier, a value of ul_carrier_id may be 1; and for 2-step RACH, a value of ul_carrier_id may be 2. The value is not specifically limited.

Optionally, the RA-RNTI may also be calculated by using a PUSCH-related calculation parameter.

Further, when the control resource set frequency domain location of the random access response in the 2-step random access procedure is the same as the control resource set frequency domain location of the random access response in the 4-step random access procedure, a random access-radio network temporary identifier of the 2-step random access procedure and a random access-radio network temporary identifier of the 4-step random access procedure use a same RNTI resource.

Further, the random access-radio network temporary identifier of the 4-step random access procedure uses the first half of the RNTI resource, and the random access-radio network temporary identifier of the 2-step random access procedure uses the last half of the RNTI resource.

In other words, if a coreset spectrum location at which the RAR is received in the 2-step RACH is the same as that in the conventional RACH, in other words, a resource is shared to receive the RAR, a segment of RNTI resource that is not occupied by another RNTI is reserved, the first half of the RNTI resource is used by an existing RA-RNTI, and the last part of the RNTI resource is applicable to the RA-RNTI in the 2-step RACH. In other words, an RNTI interval used in the 2-step RACH may be as follows: [legacy(maxRA-RNTI)+1, 2-step RACH RA-RNTI], where legacy(maxRA-RNTI) is a maximum value of the existing RA-RNTI.

Further, an association relationship between a message included in the RAR and the UE is as follows:

If the RAR is a unicast message, a UE ID corresponding to the RAR corresponds to a radio resource control connection setup message (RRC connection setup) and/or a radio resource control connection resume message (RRC resume) and/or a radio resource control reconfiguration messages included in the RAR.

If the RAR is a broadcast message and corresponds to different pieces of UE, an association relationship needs to be established between an RRC connection setup/RRC resume/radio resource control reconfiguration message in the RAR and one UE ID (which may be a contention resolution ID or an ID that can uniquely identify the UE), where one message may correspond to multiple UE IDs. The following message in the random access response corresponds to at least one user equipment identifier:

a radio resource control connection setup message;

a radio resource control connection resume message; and

a radio resource control reconfiguration message; and

another RRC message, a MAC control element, a C-RNTI, a physical layer control indicator, or the like.

Further, the random access response includes a cell radio network temporary identifier and a radio resource control message of each contention-resolved user equipment. For use of the C-RNTI in the RAR, different from a RAR in related technology, the RAR in this embodiment directly includes the C-RNTI and the RRC message of each contention-resolved UE, and the C-RNTI is included in the RRC message or the MAC CE, instead of automatically upgrading a previous T-C-RNTI to the C-RNTI.

Further, the cell radio network temporary identifier is included in a radio resource control message or a media access control control element message.

Further, the method further includes:

after identifying, based on the cell radio network temporary identifier, that the user equipment is contention-resolved user equipment, executing content of the radio resource control message. In other words, for a received RRC message, the UE executes content of the RRC message after determining that the UE is contention-resolved UE.

Further, the method further includes:

scheduling a subsequent radio resource control message based on the cell radio network temporary identifier.

In the RAR, a corresponding C-RNTI is allocated to each contention-resolved UE, and a subsequent RRC message is scheduled by using the allocated C-RNTI to transmit the RRC message.

The technical solutions in this embodiment are applicable to an NR and a subsequent evolved network.

An embodiment of the present disclosure further provides a random access information sending method that is applied to a network side device. As shown in FIG. 6, the method includes the following steps.

Step 201: Send a random access response to user equipment, where the random access response includes at least one of the following: a reserved bit, an uplink grant, a backoff indicator, a timing advance, an ID of a preamble sequence or another sequence, a terminal ID, a contention resolution ID, an RRC message, an association relationship between RRC messages and IDs, or a radio network temporary identifier in a connected state, and the IDs include at least one of the following: the ID of the preamble sequence or the another sequence, the terminal ID, or the contention resolution ID.

Further, before sending a random access response to the user equipment, the method further includes:

receiving a random access request sent by the user equipment.

Further, when the random access response is a unicast message, a user equipment identifier corresponding to the random access response corresponds to at least one of the following messages in the random access response:

a radio resource control connection setup message;

a radio resource control connection resume message; or

a radio resource control reconfiguration message.

Further, when the random access response is a broadcast message, the following messages in the random access response correspond to at least one user equipment identifier:

a radio resource control connection setup message;

a radio resource control connection resume message; and

a radio resource control reconfiguration message.

Further, the random access response includes a cell radio network temporary identifier and a radio resource control message of each contention-resolved user equipment.

Further, the cell radio network temporary identifier is included in a radio resource control message or a media access control control element message.

An embodiment of the present disclosure further provides user equipment. As shown in FIG. 7, the user equipment includes:

a receiving module 31, configured to receive a random access response sent by a network side device, where the random access response includes at least one of the following: a reserved bit, an uplink grant, a backoff indicator, a timing advance, an ID of a preamble sequence or another sequence, a terminal ID, a contention resolution ID, an RRC message, an association relationship between RRC messages and IDs, or a radio network temporary identifier in a connected state, and the IDs include at least one of the following: the ID of the preamble sequence or the another sequence, the terminal ID, or the contention resolution ID.

Content of a random access response in a 2-step random access procedure can be clear in this embodiment.

Further, the user equipment further includes:

a calculation module, configured to calculate a random access-radio network temporary identifier based on transmission resource information in a random access procedure.

The receiving module 31 is specifically configured to receive the random access response by using the random access-radio network temporary identifier.

Further, the user equipment further includes:

a sending module, configured to send a random access request to the network side device.

The transmission resource information includes a time domain resource and/or a frequency domain resource and/or a space domain resource and/or a power domain resource that are/is corresponding to a random access preamble sequence or another code sequence and that are carried in the random access request; and/or

the random access request carries a time domain resource and/or a frequency domain resource and/or a space domain resource and/or a power domain resource that are/is corresponding to a physical uplink shared channel used for transmission.

The calculation module is specifically configured to: calculate the random access-radio network temporary identifier based on the time domain resource and/or the frequency domain resource and/or the space domain resource and/or the power domain resource that are/is corresponding to the random access preamble sequence or the another code sequence and that are carried in the random access request; and/or

calculating the random access-radio network temporary identifier based on the time domain resource and/or the frequency domain resource and/or the space domain resource and/or the power domain resource that are/is corresponding to the physical uplink shared channel used for transmission.

Further, when a control resource set frequency domain location of a random access response in the 2-step random access procedure is different from a control resource set frequency domain location of a random access response in the 4-step random access procedure, the calculation module is specifically configured to calculate the random access-radio network temporary identifier by using at least one of the following parameters:

a sequence number of the first OFDM location of a PRACH corresponding to a 2-step random access procedure, a sequence number of the first timeslot of a system frame at which the PRACH channel corresponding to the 2-step random access procedure is located, a sequence number of a frequency domain location of the PRACH channel corresponding to the 2-step random access procedure, or an indication of an uplink carrier for sending the random access request.

Further, when the control resource set frequency domain location of the random access response in the 2-step random access procedure is the same as the control resource set frequency domain location of the random access response in the 4-step random access procedure, a random access-radio network temporary identifier of the 2-step random access procedure and a random access-radio network temporary identifier of the 4-step random access procedure use a same RNTI resource.

Further, the random access-radio network temporary identifier of the 4-step random access procedure uses the first half of the RNTI resource, and the random access-radio network temporary identifier of the 2-step random access procedure uses the last half of the RNTI resource.

Further, when the random access response is a unicast message, a user equipment identifier corresponding to the random access response corresponds to at least one of the following messages in the random access response:

a radio resource control connection setup message;

a radio resource control connection resume message; or

a radio resource control reconfiguration message.

Further, when the random access response is a broadcast message, the following messages in the random access response correspond to at least one user equipment identifier:

a radio resource control connection setup message;

a radio resource control connection resume message; and

a radio resource control reconfiguration message.

Further, the random access response includes a cell radio network temporary identifier and a radio resource control message of each contention-resolved user equipment.

Further, the cell radio network temporary identifier is included in a radio resource control message or a media access control control element message.

Further, the user equipment further includes:

a processing module, configured to: after identifying, based on the cell radio network temporary identifier, that the user equipment is contention-resolved user equipment, execute content of the radio resource control message.

Further, the user equipment further includes:

a scheduling module, configured to schedule a subsequent radio resource control message based on the cell radio network temporary identifier.

An embodiment of the present disclosure further provides a network side device. As shown in FIG. 8, the network side device includes:

a sending module 41, configured to send a random access response to user equipment, where the random access response includes at least one of the following: a reserved bit, an uplink grant, a backoff indicator, a timing advance, an ID of a preamble sequence or another sequence, a terminal ID, a contention resolution ID, an RRC message, an association relationship between RRC messages and IDs, or a radio network temporary identifier in a connected state, and the IDs include at least one of the following: the ID of the preamble sequence or the another sequence, the terminal ID, or the contention resolution ID.

Further, the method further includes:

a receiving module, configured to receive a random access request sent by the user equipment.

Further, when the random access response is a unicast message, a user equipment identifier corresponding to the random access response corresponds to at least one of the following messages in the random access response:

a radio resource control connection setup message;

a radio resource control connection resume message; or

a radio resource control reconfiguration message.

Further, when the random access response is a broadcast message, the following messages in the random access response correspond to at least one user equipment identifier:

a radio resource control connection setup message;

a radio resource control connection resume message; and

a radio resource control reconfiguration message.

Further, the random access response includes a cell radio network temporary identifier and a radio resource control message of each contention-resolved user equipment.

Further, the cell radio network temporary identifier is included in a radio resource control message or a media access control control element message.

An embodiment of the present disclosure further provides a network node, including a processor, a memory, and a computer program that is stored in the memory and that can run on the processor, and when the computer program is executed by the processor, steps of the random access information obtaining method described above are implemented.

The network node includes a network side device and user equipment.

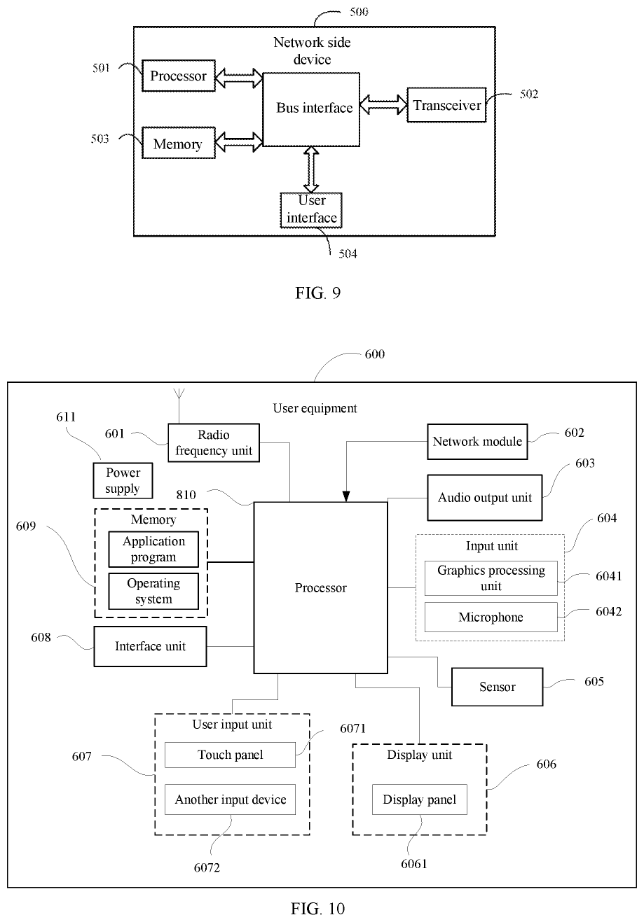

FIG. 9 is a structural diagram of a network side device to which an embodiment of the present disclosure is applied, which can implement details of the foregoing random access information sending method, and achieve the same effect. As shown in FIG. 9, the network side device 500 includes: a processor 501, a transceiver 502, a memory 503, a user interface 504, and a bus interface.

In this embodiment of the present disclosure, the network side device 500 further includes a computer program that is stored in the memory 503 and that can run on the processor 501. When the computer program is executed by the processor 501, the following steps are implemented: sending a random access response to user equipment, where the random access response includes at least one of the following: a reserved bit, an uplink grant, a backoff indicator, a timing advance, an ID of a preamble sequence or another sequence, a terminal ID, a contention resolution ID, an RRC message, an association relationship between RRC messages and IDs, or a radio network temporary identifier in a connected state, and the IDs include at least one of the following: the ID of the preamble sequence or the another sequence, the terminal ID, or the contention resolution ID.

In FIG. 9, a bus architecture may include any quantity of interconnected buses and bridges, and is specifically linked by various circuits of one or more processors represented by the processor 501 and a memory represented by the memory 503. The bus architecture may further connect together various other circuits of a peripheral device, a voltage stabilizer, a power management circuit, and the like, which are known in this art and will not be further described herein. The bus interface provides an interface. The transceiver 502 may include a plurality of elements, that is, include a transmitter and a receiver, and provide units for communication with various other apparatuses on a transmission medium. For different user equipment, the user interface 504 may alternatively be an interface for externally and internally connecting required equipment. The connected equipment includes but is not limited to a keypad, a display, a speaker, a microphone, a joystick, and the like.

The processor 501 is responsible for managing the bus architecture and common processing, and the memory 503 may store data used when the processor 501 performs an operation.

Further, when the computer program is executed by the processor 501, the following step is further implemented: receiving a random access request sent by the user equipment.

Further, when the random access response is a unicast message, a user equipment identifier corresponding to the random access response corresponds to at least one of the following messages in the random access response:

a radio resource control connection setup message;

a radio resource control connection resume message; or

a radio resource control reconfiguration message.

Further, when the random access response is a broadcast message, the following messages in the random access response correspond to at least one user equipment identifier:

a radio resource control connection setup message;

a radio resource control connection resume message; and

a radio resource control reconfiguration message.

Further, the random access response includes a cell radio network temporary identifier and a radio resource control message of each contention-resolved user equipment.

Further, the cell radio network temporary identifier is included in a radio resource control message or a media access control control element message.

An embodiment of the present disclosure further provides user equipment, including a processor, a memory, and a computer program that is stored in the memory and that can run on the processor, and when the computer program is executed by the processor, steps of the random access information obtaining method described above are implemented.

FIG. 10 is a structural diagram of user equipment for implementing all embodiments of the present disclosure. As shown in FIG. 10, user equipment 600 includes but is not limited to components such as a radio frequency unit 601, a network module 602, an audio output unit 603, an input unit 604, a sensor 605, a display unit 606, a user input unit 607, an interface unit 608, a memory 609, a processor 610, and a power supply 611. A person skilled in the art may understand that a structure of the user equipment shown in FIG. 10 does not constitute a limitation on the user equipment, and the user equipment may include more or fewer components than those shown in the figure, or combine some components, or have different component arrangements. In the embodiments of the present disclosure, the user equipment includes, but is not limited to: a mobile phone, a tablet computer, a notebook computer, a palm computer, an on-board terminal, wearable equipment, and a pedometer.

The processor 610 is configured to receive a random access response sent by a network side device, where the random access response includes at least one of the following: a reserved bit, an uplink grant, a backoff indicator, a timing advance, an ID of a preamble sequence or another sequence, a terminal ID, a contention resolution ID, an RRC message, an association relationship between RRC messages and IDs, or a radio network temporary identifier in a connected state, and the IDs include at least one of the following: the ID of the preamble sequence or the another sequence, the terminal ID, or the contention resolution ID.

Further, the processor 610 is further configured to calculate a random access-radio network temporary identifier based on transmission resource information in a random access procedure, and receive the random access response by using the random access-radio network temporary identifier.

Further, the processor 610 is further configured to send a random access request to a network side device.

The transmission resource information includes a time domain resource and/or a frequency domain resource and/or a space domain resource and/or a power domain resource that are/is corresponding to a random access preamble sequence or another code sequence and that are carried in the random access request; and/or

the random access request carries a time domain resource and/or a frequency domain resource and/or a space domain resource and/or a power domain resource that are/is corresponding to a physical uplink shared channel used for transmission.

Further, the processor 610 is specifically configured to: calculate the random access-radio network temporary identifier based on the time domain resource and/or the frequency domain resource and/or the space domain resource and/or the power domain resource that are/is corresponding to the random access preamble sequence or the another code sequence and that are carried in the random access request; and/or

calculate the random access-radio network temporary identifier based on the time domain resource and/or the frequency domain resource and/or the space domain resource and/or the power domain resource that are/is corresponding to the physical uplink shared channel used for transmission.

Further, when a control resource set frequency domain location of a random access response in the 2-step random access procedure is different from a control resource set frequency domain location of a random access response in the 4-step random access procedure, the processor 610 is further configured to calculate the random access-radio network temporary identifier by using at least one of the following parameters:

a sequence number of the first OFDM location of a PRACH corresponding to a 2-step random access procedure, a sequence number of the first timeslot of a system frame at which the PRACH channel corresponding to the 2-step random access procedure is located, a sequence number of a frequency domain location of the PRACH channel corresponding to the 2-step random access procedure, or an indication of an uplink carrier for sending the random access request.

Further, when the control resource set frequency domain location of the random access response in the 2-step random access procedure is the same as the control resource set frequency domain location of the random access response in the 4-step random access procedure, a random access-radio network temporary identifier of the 2-step random access procedure and a random access-radio network temporary identifier of the 4-step random access procedure use a same RNTI resource.

Further, the random access-radio network temporary identifier of the 4-step random access procedure uses the first half of the RNTI resource, and the random access-radio network temporary identifier of the 2-step random access procedure uses the last half of the RNTI resource.

Further, when the random access response is a unicast message, a user equipment identifier corresponding to the random access response corresponds to at least one of the following messages in the random access response:

a radio resource control connection setup message;

a radio resource control connection resume message; or

a radio resource control reconfiguration message.

Further, when the random access response is a broadcast message, the following messages in the random access response correspond to at least one user equipment identifier:

a radio resource control connection setup message;

a radio resource control connection resume message; and

a radio resource control reconfiguration message.

Further, the random access response includes a cell radio network temporary identifier and a radio resource control message of each contention-resolved user equipment.

Further, the cell radio network temporary identifier is included in a radio resource control message or a media access control control element message.

Further, the processor 610 is further configured to: after identifying, based on the cell radio network temporary identifier, that the user equipment is contention-resolved user equipment, execute content of the radio resource control message.

Further, the processor 610 is further configured to schedule a subsequent radio resource control message based on the cell radio network temporary identifier.

It should be understood that, in this embodiment of the present disclosure, the radio frequency unit 601 may be configured to receive and send information or receive and send a signal in a call process. Specifically, after downlink data from a base station is received, the processor 610 processes the downlink data. In addition, uplink data is sent to the base station. Generally, the radio frequency unit 601 includes but is not limited to an antenna, at least one amplifier, a transceiver, a coupler, a low noise amplifier, a duplexer, and the like. In addition, the radio frequency unit 601 may further communicate with a network and another device through wireless communication.

The user equipment provides, through the network module 602, users with wireless broadband Internet access, for example, helping users receive and send e-mails, browse web pages and access stream-media, etc.

The audio output unit 603 can convert audio data received by the radio frequency unit 601 or the network module 602 or stored in the memory 609 into an audio signal, and output the audio signal as sound. Moreover, the audio frequency output unit 603 can further provide audio frequency outputs related to specific functions conducted by the user equipment 600 (for example, call receiving sound, message receiving sound, etc.). The audio output unit 603 includes a loudspeaker, a buzzer, a telephone receiver, and the like.

The input unit 604 is configured to receive an audio or video signal. The input unit 604 may include a graphics processing unit (GPU) 6041 and a microphone 6042. The graphics processing unit 6041 processes image data of a static picture or video obtained by an image capture apparatus (such as a camera) in a video capture mode or an image capture mode. A processed image frame may be displayed on the display unit 606. The image frame processed by the graphics processing unit 6041 can be stored in the memory 609 (or another storage medium) or sent via the radio frequency unit 601 or the network module 602. The microphone 6042 may receive sound and can process such sound into audio data. The processed audio data may be converted in a telephone call mode into a format that can be sent by the radio frequency unit 601 to a mobile communications base station for output.

The user equipment 600 can further include at least one type of sensor 605, for example, a light sensor, a motion sensor and another sensor. Specifically, the light sensor includes an ambient light sensor and a proximity sensor. The ambient light sensor can adjust the brightness of a display panel 6061 according to the ambient light intensity. The proximity sensor can switch off the display panel 6061 and/or back light when the user equipment 600 moves close to an ear. As a motion sensor, an accelerometer sensor can detect accelerations in all directions (generally on three axes), can detect gravity and its direction in a static mode, can be configured to recognize postures of the user equipment (for example, switching between portrait screen and landscape screen, related games, magnetometer posture calibration), and recognize vibrations (for example, a pedometer or a stroke). The sensor 605 can also include a fingerprint sensor, a pressure sensor, an iris sensor, a molecular sensor, a gyroscope, a barometer, a hygrometer, a thermometer, an infrared sensor, etc., which will not be described in detail herein.

The display unit 606 is configured to display information entered by a user or information provided for the user. The display unit 606 may include a display panel 6061, and the display panel 6061 may be configured in a form of a liquid crystal display (LCD), an organic light-emitting diode (OLED), or the like.

The user input unit 607 can be configured to receive entered number or character information, and generate key signal input related to user settings and function control of the user equipment. Specifically, the user input unit 607 includes a touch panel 6071 and another input device 6072. The touch panel 6071, also referred to as a touchscreen, may collect a touch operation performed by the user on or near the touch panel 6071 (for example, an operation performed by the user on or near the touch panel 6071 by using any suitable object or accessory such as a finger or a stylus). The touch panel 6071 may include two parts: a touch detection apparatus and a touch controller. The touch detection apparatus detects a touch position of a user, detects a signal brought by a touch operation, and transmits the signal to the touch controller. The touch controller receives touch information from the touch detection apparatus, converts the touch information into contact coordinates, sends the contact coordinates to the processor 610, and receives and executes a command from the processor 610. In addition, the touch panel 6071 can be implemented in various types such as resistive, capacitive, infrared, and surface acoustic waves. The user input unit 607 may include another input device 6072 in addition to the touch panel 6071. Specifically, the another input device 6072 may include but is not limited to one or more of a physical keyboard, a function key (such as a volume control key or an on/off key), a trackball, a mouse, a joystick, and the like. Details are not described herein.

Further, the touch panel 6071 can cover the display panel 6061. When detecting a touch operation on or near the touch panel 6071, the touch panel 6071 transmits the touch operation to the processor 610 to determine a type of a touch event. Then the processor 610 provides corresponding visual output on the display panel 6061 based on the type of the touch event. In FIG. 10, the touch panel 6071 and the display panel 6061 as two separate parts implement input and output functions of the user equipment. However, in some embodiments, the touch panel 6071 and the display panel 6061 can be integrated to implement the input and output functions of the user equipment, which is not specifically defined herein.

The interface unit 608 is an interface for connecting an external device and the user equipment 600. For example, the external apparatus may include a wired or wireless headset port, an external power supply (or battery charger) port, a wired or wireless data port, a storage card port, a port configured to connect to an apparatus having an identification module, an audio input/output (I/O) port, a video I/O port, a headset port, and the like. The interface unit 608 can be configured to receive input from the external device (for example, data information and power) and transmits the received input to one or more elements in the user equipment 600, or can be configured to transmit data between the user equipment 600 and the external device.

The memory 609 can be configured to store software programs and various data. The memory 609 may mainly include a program storage area and a data storage area. The program storage area may store an operating system, an application program required by at least one function (such as a voice playing function and an image playing function), and the like, and the data storage area may store data (such as audio data and a phone book) created based on use of the mobile phone, and the like. In addition, the memory 609 may include a high-speed random access memory or a nonvolatile memory, for example, at least one disk storage device, a flash memory, or another volatile solid-state storage device.

The processor 610 is a control center of the user equipment, connecting all parts of the user equipment using various interfaces and circuits. By running or executing software programs and/or modules stored in the memory 609 and by calling data stored in the memory 609, the processor 610 implements various functions of the user equipment and processes data, thus performing overall monitoring on the user equipment. The processor 610 can include one or more processing units. Preferably, the processor 610 can be integrated with an application processor and a modem processor. The application processor mainly processes the operating system, the user interface, applications, etc. The modem processor mainly processes wireless communication. It can be understood that the above-mentioned modem processor is not necessarily integrated into the processor 610.

The user equipment 600 may further include the power supply 611 (such as a battery) that supplies power to each component. Preferably, the power supply 611 may be logically connected to the processor 610 by using a power management system, to implement functions such as charging, discharging, and power consumption management by using the power management system.

In addition, the user equipment 600 includes some function modules, which are not shown and will not be described in detail herein.

An embodiment of the present disclosure further provides a computer-readable storage medium, where the computer-readable storage medium stores a computer program, and when the computer program is executed by a processor, steps in the foregoing random access information obtaining method are implemented, or steps in the foregoing random access information sending method are implemented.

It can be understood that those embodiments described herein can be implemented with hardware, software, firmware, middleware, microcode or their combinations. For hardware implementation, the processing unit may be implemented in one or more application specific integrated circuits (ASIC), a digital signal processor (DSP), a digital signal processing device (DSPD), a programmable logic device (PLD), a field-programmable gate array (FPGA), a general-purpose processor, a controller, a microcontroller, a microprocessor, another electronic unit configured to perform the functions described in the present application, or a combination thereof.

For implementation with software, the technology described herein can be implemented by executing modules for functions described herein (for example, process and function). Software codes can be stored in the memory and executed by the processor. The memory can be implemented inside or outside the processor.

The embodiments in this specification are described in a progressive manner. Each embodiment focuses on a difference from another embodiment. For a same or similar part of the embodiments, refer to each other.

Those skilled in the art shall understand that the embodiments of the present disclosure can be provided as methods, devices or computer program products. Therefore, the embodiments of the present disclosure can be complete hardware embodiments, complete software embodiments, or software-hardware combined embodiments. Further, the embodiments of the present disclosure may be used in a form of a computer program product implemented on one or more computer-usable storage media (including but not limited to a disk memory, a CD-ROM, an optical memory, and the like) including computer-usable program code.

The embodiments of the present disclosure are described with reference to the flowcharts and/or block diagrams of the methods, user equipment (system), and computer program products thereof. It should be understood that computer program commands can be used to implement each of the procedures and/or blocks in the flowcharts and/or block diagrams, and combinations of procedures and/or blocks in the flowcharts and/or block diagrams. Those computer program commands can be provided in a general computer, a special computer, an embedded processor or another processor which can program data processing user equipment to generate a machine, so that the commands, executed by the computer or another processor that can program data processing user equipment, generate a device for implementing one or more procedures of the flowchart and/or conducting specific functions designed by one or more blocks of the block diagram.

Those computer program commands can further be stored in a computer readable memory, which can guide a computer or another programmable data processing user equipment to work in a specific manner, so that the commands stored in the computer readable memory generate a manufactured product including a command device. The command device implements one or more procedures in the flowchart and/or one or more blocks in the block diagram.

Those computer program commands can further be loaded onto a computer or another programmable data processing user equipment, so that a series of steps are executed in the computer or the programmable user equipment to generate processing for computer implementation. Thus, commands executed in the computer or another programmable user equipment provide steps for implementing one or more procedures of the flowchart and/or steps for conducting functions specified in one or more blocks of the block diagram.

Despite description of some embodiments of the present disclosure, once those skilled in the art know basic creative concepts, they can make changes and modifications to those embodiments. Therefore, the appended claims are intended to be interpreted as including the disclosed embodiments and all changes and modifications which fall within the scope of the present disclosure.

It should be noted that in this text the relational terms such as “first” and “second” are merely used to distinguish one object or operation from another object or operation, and do not necessarily require or hint that those objects or operations have any such actual relationship or are in such actual sequence. Moreover, terms “including”, “comprising”, or any other variants are used to cover non-exclusive inclusion, so that processes, methods, articles or user equipment, each of which includes a series of factors, include not only those factors but also other unlisted factors, or further include other inherent factors of such processes, methods, articles or user equipment. Without more limitations, the factors defined by sentences “including one . . . ” do not exclude that the processes, methods, articles or user equipment including the above-mentioned factors also incorporate other identical factors.

The above embodiments are some embodiments of the present disclosure. It should be noted that, within the technical concept of the present disclosure, those ordinarily skilled in the art can make various improvements and modifications, which shall all fall within the protective scope of the present disclosure.

What is claimed is:

1. A random access information obtaining method, applied to user equipment, and the method comprising:
receiving a random access response sent by a network side device, wherein the random access response comprises at least one of the following: a reserved bit, an uplink grant, a backoff indicator, a timing advance, an identifier (ID) of a preamble sequence or another sequence, a terminal ID, a contention resolution ID, a radio resource control (RRC) message, an association relationship between RRC messages and IDs, or a radio network temporary identifier in a connected state, and the IDs comprise at least one of the following: the ID of the preamble sequence or the another sequence, the terminal ID, or the contention resolution ID.

2. The random access information obtaining method according to claim 1, further comprising:
calculating a random access-radio network temporary identifier based on transmission resource information in a random access procedure; wherein
receiving the random access response sent by the network side device comprises:
receiving the random access response by using the random access-radio network temporary identifier.

3. The random access information obtaining method according to claim 2, wherein, before receiving the random access response sent by the network side device, the method further comprises:
sending a random access request to the network side device; wherein
the transmission resource information comprises at least one of a time domain resource, frequency domain resource, space domain resource, or power domain resource that is corresponding to a random access preamble sequence or another code sequence and that is carried in the random access request; or
the random access request carries at least one of a time domain resource, frequency domain resource, space domain resource, or power domain resource that is corresponding to a physical uplink shared channel used for transmission.

4. The random access information obtaining method according to claim 3, wherein calculating the random access-radio network temporary identifier comprises:
calculating the random access-radio network temporary identifier based on at least one of the time domain resource, frequency domain resource, space domain resource, or power domain resource that is corresponding to the random access preamble sequence or the another code sequence and that is carried in the random access request; or
calculating the random access-radio network temporary identifier based on at least one of the time domain resource, frequency domain resource, space domain resource, or power domain resource that is corresponding to the physical uplink shared channel used for transmission.

5. The random access information obtaining method according to claim 2, wherein, when a control resource set frequency domain location of the random access response is different from a control resource set frequency domain location of a random access response in a 4-step random access procedure, the random access-radio network temporary identifier is calculated by using at least one of the following parameters:
a sequence number of a first orthogonal frequency division multiplexing symbol (OFDM) location of a physical random access channel (PRACH) corresponding to a 2-step random access procedure, a sequence number of the first timeslot of a system frame at which the PRACH channel corresponding to the 2-step random access procedure is located, a sequence number of a frequency domain location of the PRACH channel corresponding to the 2-step random access procedure, or an indication of an uplink carrier for sending the random access request.

6. The random access information obtaining method according to claim 2, wherein, when a control resource set frequency domain location of the random access response is the same as a control resource set frequency domain location of a random access response in a 4-step random access procedure, the random access-radio network temporary identifier and a random access-radio network temporary identifier in the 4-step random access procedure use a same radio network temporary identifier resource.

7. The random access information obtaining method according to claim 6, wherein the random access-radio network temporary identifier in the 4-step random access procedure uses a first half of the radio network temporary identifier resource, and the random access-radio network temporary identifier uses a last half of the radio network temporary identifier resource.

8. The random access information obtaining method according to claim 1, wherein, when the random access response is a unicast message, a user equipment identifier corresponding to the random access response corresponds to at least one of the following messages in the random access response:
a radio resource control connection setup message;
a radio resource control connection resume message; or
a radio resource control reconfiguration message.

9. The random access information obtaining method according to claim 1, wherein, when the random access response is a broadcast message, the following messages in the random access response correspond to at least one user equipment identifier:
a radio resource control connection setup message;
a radio resource control connection resume message; and
a radio resource control reconfiguration message.

10. The random access information obtaining method according to claim 1, wherein the random access response comprises a cell radio network temporary identifier and a radio resource control message of each contention-resolved user equipment.

11. The random access information obtaining method according to claim 10, further comprising:
after identifying, based on the cell radio network temporary identifier, that the user equipment is contention-resolved user equipment, executing content of the radio resource control message.

12. The random access information obtaining method according to claim 10, further comprising:
scheduling a subsequent radio resource control message based on the cell radio network temporary identifier.

13. User equipment, comprising: a processor, a memory, and a computer program that is stored in the memory and that is executable on the processor, wherein the computer program, when executed by the processor, causes the processor to:
receive a random access response sent by a network side device, wherein the random access response comprises at least one of the following: a reserved bit, an uplink grant, a backoff indicator, a timing advance, an ID of a preamble sequence or another sequence, a terminal ID, a contention resolution ID, an RRC message, an association relationship between RRC messages and IDs, or a radio network temporary identifier in a connected state, and the IDs comprise at least one of the following: the ID of the preamble sequence or the another sequence, the terminal ID, or the contention resolution ID.

14. The user equipment according to claim 13, wherein the computer program, when executed by the processor, further causes the processor to:
calculate a random access-radio network temporary identifier based on transmission resource information in a random access procedure; and
receive the random access response by using the random access-radio network temporary identifier.

15. The user equipment according to claim 14, wherein the computer program, when executed by the processor, further causes the processor to:
send a random access request to the network side device; wherein
the transmission resource information comprises at least one of a time domain resource, frequency domain resource, space domain resource, or power domain resource that is corresponding to a random access preamble sequence or another code sequence and that is carried in the random access request; or
the random access request carries at least one of a time domain resource, frequency domain resource, space domain resource, or power domain resource that is corresponding to a physical uplink shared channel used for transmission.

16. The user equipment according to claim 15, wherein, to calculate the random access-radio network temporary identifier, the computer program, when executed by the processor, further causes the processor to:
calculate the random access-radio network temporary identifier based on at least one of the time domain resource, frequency domain resource, space domain resource, or power domain resource that is corresponding to the random access preamble sequence or the another code sequence and that is carried in the random access request; or
calculate the random access-radio network temporary identifier based on at least one of the time domain resource, frequency domain resource, space domain resource, or power domain resource that is corresponding to the physical uplink shared channel used for transmission.

17. The user equipment according to claim 14, wherein, when a control resource set frequency domain location of the random access response is different from a control resource set frequency domain location of a random access response in a 4-step random access procedure, the computer program, when executed by the processor, further causes the processor to:
calculate the random access-radio network temporary identifier by using at least one of the following parameters: a sequence number of the first OFDM location of a physical random access channel (PRACH) corresponding to a 2-step random access procedure, a sequence number of the first timeslot of a system frame at which the PRACH channel corresponding to the 2-step random access procedure is located, a sequence number of a frequency domain location of the PRACH channel corresponding to the 2-step random access procedure, or an indication of an uplink carrier for sending the random access request.

18. The user equipment according to claim 14, wherein, when a control resource set frequency domain location of the random access response is the same as a control resource set frequency domain location of a random access response in a 4-step random access procedure, the random access-radio network temporary identifier and a random access-radio network temporary identifier in the 4-step random access procedure use a same radio network temporary identifier resource.

19. A network side device, comprising: a processor, a memory, and a computer program that is stored in the memory and that is executable on the processor, wherein the computer program, when executed by the processor, causes the processor to:
send a random access response to user equipment, wherein the random access response comprises at least one of the following: a reserved bit, an uplink grant, a backoff indicator, a timing advance, an ID of a preamble sequence or another sequence, a terminal ID, a contention resolution ID, an RRC message, an association relationship between RRC messages and IDs, or a radio network temporary identifier in a connected state, and the IDs comprise at least one of the following: the ID of the preamble sequence or the another sequence, the terminal ID, or the contention resolution ID.

20. The network side device according to claim 19, wherein the computer program, when executed by the processor, further causes the processor to:
receive a random access request sent by the user equipment.
